(19) United States
(12) Patent Application Publication
(10) Pub. No.: US 2025/0232386 A1
(43) Pub. Date: Jul. 17, 2025

(54) Opportunity Identification And Response Creation Methods And Apparatus

(71) Applicant: Edgar Green, Fort Lauderdale, FL (US)

(72) Inventor: Edgar Green, Fort Lauderdale, FL (US)

(21) Appl. No.: 18/413,520

(22) Filed: Jan. 16, 2024

(51) Int. Cl. G06Q 50/00

(52) U.S. Cl. CPC G06Q 50/01

(57) ABSTRACT

Methods and apparatus for identifying from the internet and notifying a user of multiple opportunities and personal improvement recommendations, that comprise a User Profile Creation Module for creating a user profile; an Opportunity Database Creation Module for creating user specific databases of opportunities and improvement recommendations; an AI Matching Module for matching opportunities and improvement recommendations with the user profile; a Notification Module for informing the user of the matching opportunities and improvement recommendations and creating an artifact such as a custom profile, curriculum vitae, and/or resume; a User Feedback Module for providing feedback; and an Automation Module for affecting applications for the opportunities. In addition, a module that creates a custom profile/curriculum vitae/resume or content regarding such that facilitates and/or improves the user's application for the opportunity. The opportunities identified by the invention can include jobs, dating, business, and/or others.

### FIELD OF THE INVENTION

The invention relates to methods and apparatus for the intelligent identification from the internet of opportunities such as improvement recommendations, job opportunities or listings, potential romantic matches, business opportunities, proposals and suggestions, and the creation of useful responses.

### BACKGROUND OF THE INVENTION

Methods and apparatus for identifying web based opportunities, such as improvement recommendations, advertisements, job descriptions or listings, proposals, and suggestions, have been limited by being overly time-consuming, inaccurate, untimely, incomplete and tedious. Methods and apparatus for intelligently identifying and creating useful, targeted and timely responses to such opportunities using, among other things, Artificial Intelligence (“AI”), are needed.

New methods and apparatus for the intelligent identification of opportunities and creating useful responses that save time, are more accurate and complete, and/or that are less tedious are needed and are objects of this invention.

### SUMMARY OF THE INVENTION

New methods and apparatus for the intelligent identification of opportunities, such as matching users with personalized opportunities, and then creating a useful response, are provided for by certain embodiments of this invention. These methods and apparatus use AI models to match users with opportunities based on the user's profile and interests from collecting detailed information about the user. The methods and apparatus use web crawlers and/or application program interfaces (“API”) that scrape various websites to create a database of opportunities. The methods and apparatus also make improvement recommendations to users on how to increase their chances of success in their responses to the opportunities such as, in the case of job applications, with personal growth/training. Notifications are sent to users via email or other electronic communication methods that contain information needed to make a decision on the opportunity and system creates a targeted response by leveraging AI technology (e.g., they may provide a draft resume for a job search or a response to a business opportunity or romantic relationship inquiry). The methods and apparatus provides a comprehensive solution for users who are looking for opportunities in multiple categories, reducing the need for users to continuously check the platform or the internet more generally for new opportunities, providing less time-consuming, more accurate and complete, and/or less tedious advantages. The methods and apparatus can maintain and publish an API that allows other systems to deliver the same or similar services to their users.

A preferred method of this invention is a method for identifying from the internet, and notifying a user of, (i) multiple opportunities specific for the user, and (ii) multiple improvement recommendations specific for the user increasing the user's chance of successfully landing the opportunity. The method comprises: (a) creating a user profile of at least three different personal information categories concerning the user from information input by the user and/or collected from social media concerning the user; (b) creating a first opportunity database using multiple webcrawlers and/or multiple application program interfaces to collect from the internet and store in the first opportunity database multiple opportunities; (c) creating a second opportunity database (e.g., a skills database) using multiple webcrawlers and/or multiple application program interfaces to collect from the internet and store in the second opportunity database multiple personal improvement recommendations; (d) matching the contents of the first opportunity database with the user profile using artificial intelligence to identify multiple opportunities specific for the user; (e) matching the contents of the second opportunity database with the user profile using artificial intelligence to identify multiple improvement recommendations specific for the user; (f) notifying the user of the multiple opportunities specific for the user; (g) notifying the user of the multiple improvement recommendations specific for the user; (h) providing feedback to the step (d) matching and the step (c) matching on the usefulness of the multiple opportunities specific for the user and the multiple improvement recommendations specific for the user; (i) creating an artifact that the user leverages to apply for the opportunity (e.g., customized resume, customized profile, customized curriculum vitae (“CV”), customized response), which will facilitate (e.g., improve) the user's application to the opportunity; and (j) otherwise responding to an opportunity on behalf of the user (unattended) by, for example, responding to the opportunity with an application or other form filed out by a component (e.g., module) of the invention. As used herein an “application” and “applying” can mean affecting any form or request that seeks information from a user that is then provided by an embodiment of this invention to apply or otherwise seek the opportunity, such as providing information for a job application, providing requested personal information, providing responses to questions, etc.

A preferred apparatus (e.g., comprised of interconnected and/or communicating components (e.g., modules)) of this invention is an apparatus for identifying from the internet, and notifying a user of, (i) multiple opportunities specific for the user, and (ii) multiple personal improvement recommendations specific for the user. The apparatus comprises: (a) a User Profile Creation Module that is used to create a user profile of at least three different personal information categories concerning the user from information input by the user and/or collected from social media concerning the user; (b) an Opportunity Database Creation Module that creates (i) a first opportunity database from multiple webcrawlers and/or multiple application program interfaces that collect from the internet and store in the first opportunity database multiple opportunities, and (ii) a second opportunity database using multiple webcrawlers and/or multiple application program interfaces to collect from the internet and store in the second opportunity database multiple improvement recommendations; (c) an AI Matching Module that matches (i) the contents of the first opportunity database with the user profile using artificial intelligence to identify multiple opportunities specific for the user, and (ii) the contents of the second opportunity database with the user profile using artificial intelligence to identify multiple improvement recommendations specific for the user; (d) a Notification Module that informs the user of (i) the multiple opportunities specific for the user, and (ii) the multiple improvement recommendations specific for the user, as well as creating an artifact that the user leverages to apply for the opportunity (customized resume, customized response), specific for each opportunity; (e) a User Feedback Module that provides feedback from the user on the multiple opportunities specific for the user, and the multiple improvement recommendations specific for the user, to the AI Matching Module to improve the matching results of the AI Matching Module; and (f) an Automation Module, that responds to an opportunity on behalf of the user (unattended).

In certain highly preferred embodiments, the methods and apparatus of this invention comprise a set of steps implemented by an engine that includes the Opportunity Database Creation Module and the AI Matching Module at its base, which can be applied to each different use described herein. Similar to the Opportunity Database Creation Module, the AI Matching Module and internal algorithms determine if a user's profile is a match, for a role. If the user indicates that they want a role, and their profile is not a match (i.e., it does not meet a certain threshold), the algorithms of these embodiments will create a training plan that will increase the probability percentage until the user is within the match threshold. This process will be repeated for other use cases. For example, if a user wants to date people of a different culture, the probability will be determined using the Opportunity Database Creation Module, and the Notification Module will recommend language classes, music, restaurants, reading, movies, travel opportunities, dance classes or videos, readings/videos on etiquette and other cultural norms.

In certain highly preferred embodiments, the methods and apparatus of this invention will determine the distance between the user and what she/he wants to achieve (e.g., via a User Feedback Module and Notification Module). If they are close the system will create a narrative, script, resume, cover letter, profile, copy, etc. that will improve the user's chance of being selected. If the distance is further than optimal for selection the system will create a custom training, improvement, enhancement and/or development plan. The plan's assumed improvements will be added to the user's profile, and the new profile will be reevaluated until the potential distance-score is close enough to increase the user's chance of landing the opportunity. The user completes the development plan and the system will create the artifacts described above (resume, etc.) so that the user can apply.

In certain highly preferred embodiments, the methods and apparatus of this invention will apply for opportunities on the user's behalf for each of the opportunities that the user is qualified for (e.g., distance score within range) (e.g., via an Automation Module). Each application for the opportunity will be unique. AI will determine the job role, date, business opportunity, etc. most suited or most achievable and apply on the user's behalf. The particular application can be a resume, a message to the user's profile in a dating app, a message to a potential client, etc.

Advantages of the embodiments of this invention are described and apparent throughout this specification. For example, embodiments of this invention may provide one or more of the following:
Multiple Opportunities: A preferred embodiment of this invention is configured to offer users opportunities in two or more categories, including, for example, jobs and dates, whereas a platforms that only offers users opportunities in one category is less useful and more limiting.
Detailed Profile: This invention requires users to create a detailed profile, with at least three attributes, which is used to match them with relevant opportunities. A platform that requires less information or uses more basic matching criteria, such as keywords or job titles, will make less accurate and/or useful matches.
AI Improvement Recommendations: This invention not only matches users with opportunities but also provides improvement recommendations on how to increase their chances of landing the opportunity. This feature is unique and can help users improve their skills and knowledge to succeed in their career or personal life.
Opportunity Database: A preferred embodiment of this uses multiple web crawlers that create a database of opportunities from various sources, which allows users to access a wide range of opportunities in one place. A platform that relies on a limited number of job boards or other sources could result in users missing out on opportunities.
Notification: A preferred embodiment of this invention notifies users about opportunities via email and or messaging, which reduces the need for users to continuously check the platform for new opportunities
Automation: An advanced feature of this invention is that the system will apply for opportunities on behalf of the user based on the system's analysis of the user's profile and the likelihood/probability that the user will win the opportunity. This feature may provide a custom profile, CV and/or resume, as an example, to the opportunity.

This invention sets itself apart by offering a broad range of services beyond just job searching and recruiting. Unlike a system primarily focused on resume building and matching candidates with job openings, this invention places a greater emphasis on helping users improve themselves, their probability of success and their skills in order to increase their chances of finding opportunities. This invention helps users to develop and showcase their unique strengths and qualifications to potential employers or other opportunities beyond traditional job searches.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a diagram that illustrates the detailed information that is gathered from users in certain embodiments of this invention, which is used by these embodiments to provide recommendations to the user.

FIG. 2 is a diagram that illustrates examples of various dedicated services used by certain embodiments of this invention that scour the web for available opportunities.

FIG. 3 is a diagram that illustrates examples of specialized services that certain embodiments of this invention identify that help users develop their skills to increase their chances of securing opportunities.

FIG. 4 is a diagram that illustrates the integration of modules of certain embodiments of this invention.

FIG. 5 is a diagram that illustrates the general integration of modules of certain embodiments of this invention that can be applied to various applications (i.e., not limited to job search applications).

FIG. 6 is a diagram that illustrates a specific embodiment of the User Creation Step.

FIG. 7 is a diagram of an embodiment of a creation of an interest opportunity database.

FIG. 8 is a diagram of an embodiment of a creation of a personal improvement database.

FIG. 9 is a diagram of an embodiment of the matching of a user profile to opportunities.

FIG. 10 is a diagram of an embodiment of an improvement recommendation.

FIG. 11 is a diagram of an embodiment of a dynamic resume generator.

FIG. 12 is a diagram of an embodiment of an email alert set to a user.

FIG. 13 is a diagram of an embodiment of the building of a jobs database.

FIG. 14 is a diagram of an embodiment of the building of a course database.

### DETAILED DESCRIPTION OF THE INVENTION

The invention provides for several steps in the methods and several components in the apparatus that are used. These steps can be implemented in one or more modules. One module can perform one step, or one module can perform part of a step or multiple steps. These steps can be used in the order set forth below, or in another order depending on the application and what has been done before (e.g., in response to feedback, which is described further below), which will be apparent to a person of skill in the art. Exemplary steps and modules and their interactions are described below.

1. User Profile Creation: A step for embodiments of this invention can be for the user to create a detailed profile. The user will provide information such as their education, work experience, skills, interests, and preferences, depending on the application. This information will be used by the embodiments of this invention for AI models to match the user with opportunities.

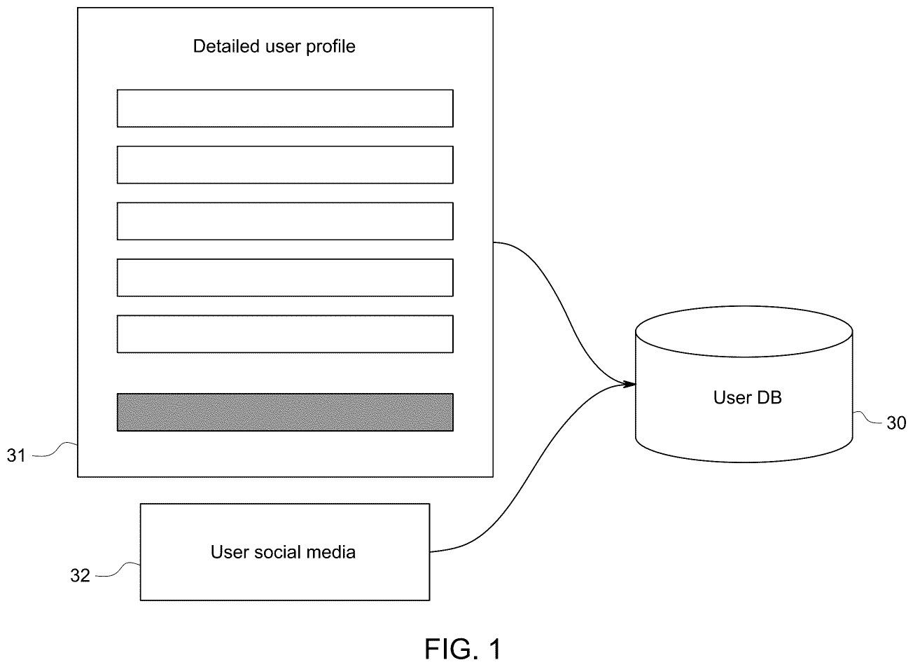

FIG. 1 is a diagram that illustrates the detailed information that is gathered from users in certain embodiments of this invention, which is used to provide recommendations to the user. A “Detailed user profile” 31 is created. Generally, the more information collected, the better the improvement recommendations and identified opportunities may be. For example, for job search applications, this information may include personal preferences, past work experience, education, skills, and interests. Additionally, publicly available social media information (e.g., “User social media” 32) may be utilized to build a more comprehensive Detailed user profile 31. All of the information collected about the user will be stored in a secure database (e.g., “User DB” 30) and will be utilized by the embodiments of this invention to match the user with relevant opportunities that fit their profile. This approach helps the methods and apparatus provide more personalized recommendations to the user and increase their chances of success in finding suitable opportunities.

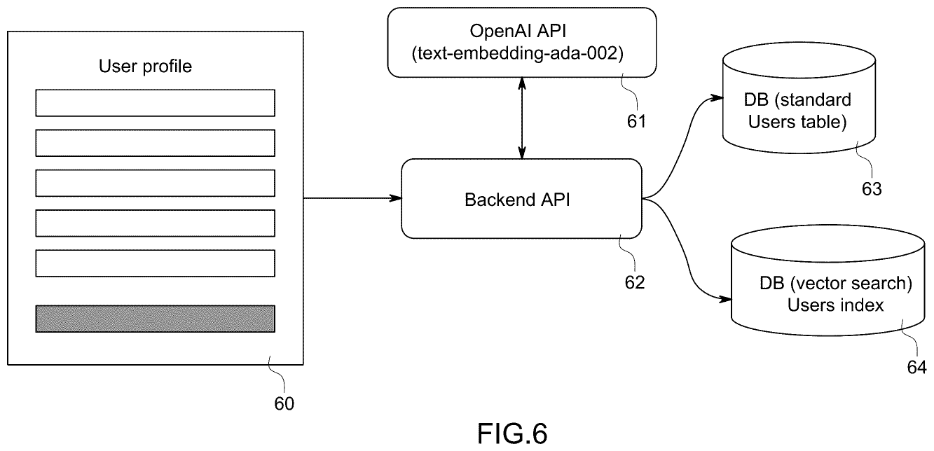

FIG. 6 is a diagram that illustrates a specific embodiment of the User Creation Step. It uses a User profile 60, an OpenAI API 61 that interacts with a Backend AI API 62, which in turn interacts with a standard database 63 and a vector search database 64.

This User Profile Creation step can be implemented in one or more “User Profile Creation Modules” (or be combined with one or more other modules).

2. Opportunity Database Creation: Another step for embodiments of this invention is to create a database of opportunities. This is done using web crawlers and/or APIs to the source system, which are automated scripts that search the web for opportunities on various platforms. The web crawlers will scrape job boards, social media platforms, RFP/RFQ/grant portals and other websites depending on the application to find opportunities that match the user's profile. In addition to scraping, the embodiments of this invention can also leverage APIs into other systems to find opportunities.

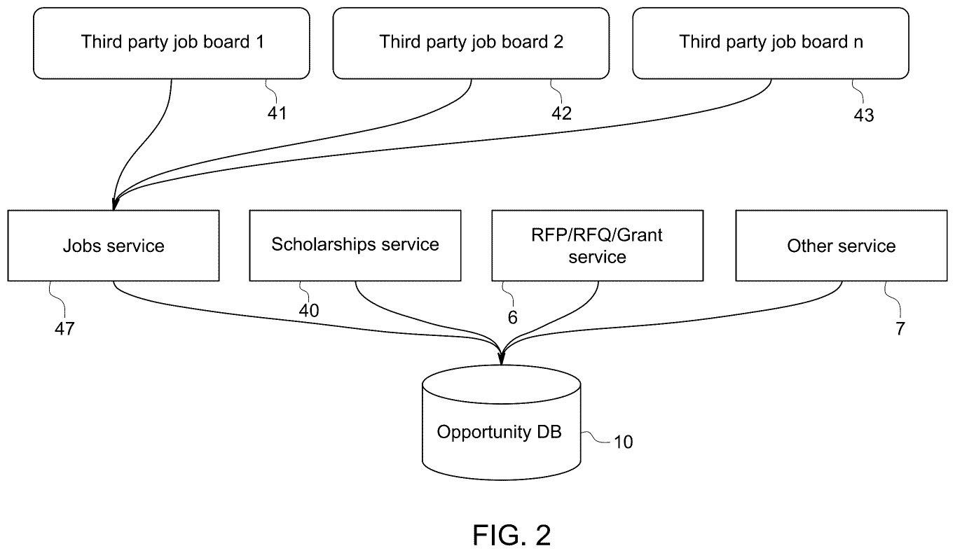

FIG. 2 is a diagram that illustrates examples of the various dedicated services used by certain embodiments of this invention that scour the web for available opportunities in job search applications (e.g., “Third party job board 1” 1; “Third party job board 2” 2; Third party job board n” 3; “Jobs service” 4; “Scholarships service” 5; “Events service” 6; “Other services” 7). These services collect all the relevant opportunities and store them in a centralized opportunity database (e.g., “Opportunity DB” 10), which is accessed by the backend of each of the embodiments. The backend matches these opportunities with the user's detailed information, such as skills, experience, and preferences, resulting in a personalized list of opportunity recommendations according to a given application. By leveraging multiple sources of data, the embodiments offer a comprehensive solution for opportunity seekers that is tailored to their individual needs and preferences.

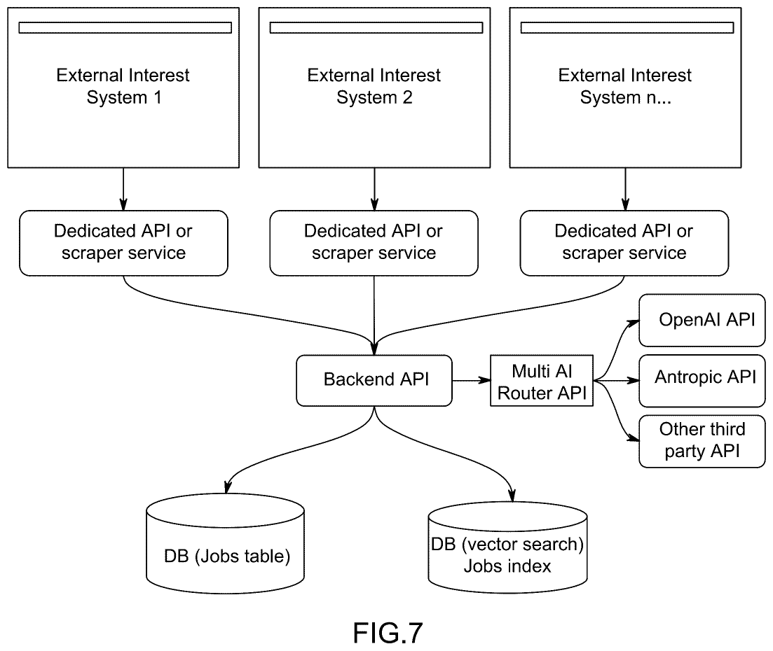

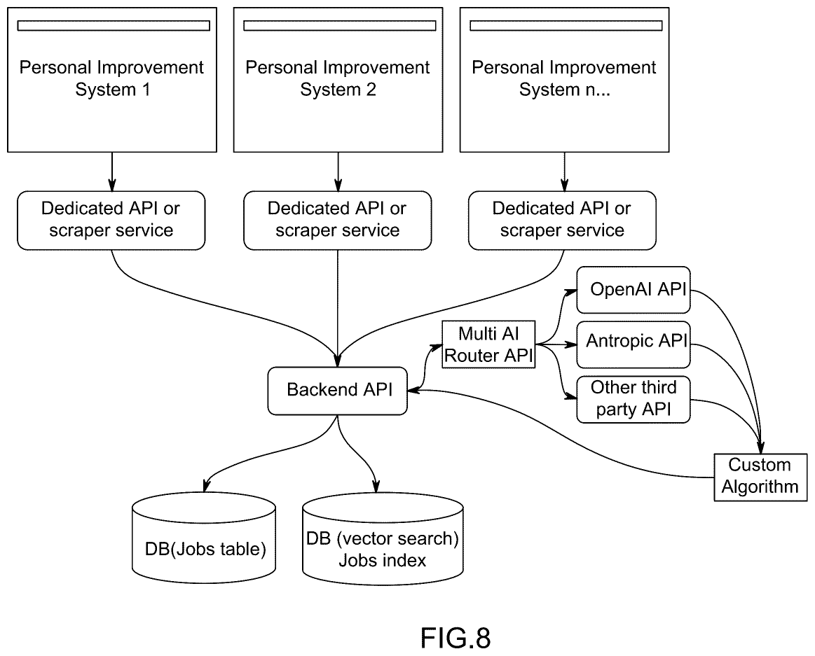

FIG. 7 is a diagram of an embodiment of a creation of an interest opportunity database of this step, showing how the external interest systems interact with dedicated API or scraper services, the backend API, and databases, among other components. FIG. 8 is a diagram of an embodiment of a creation of a personal improvement database, showing how personal improvement systems interact with dedicated API or scraper services, the backend API, and databases, among other components.

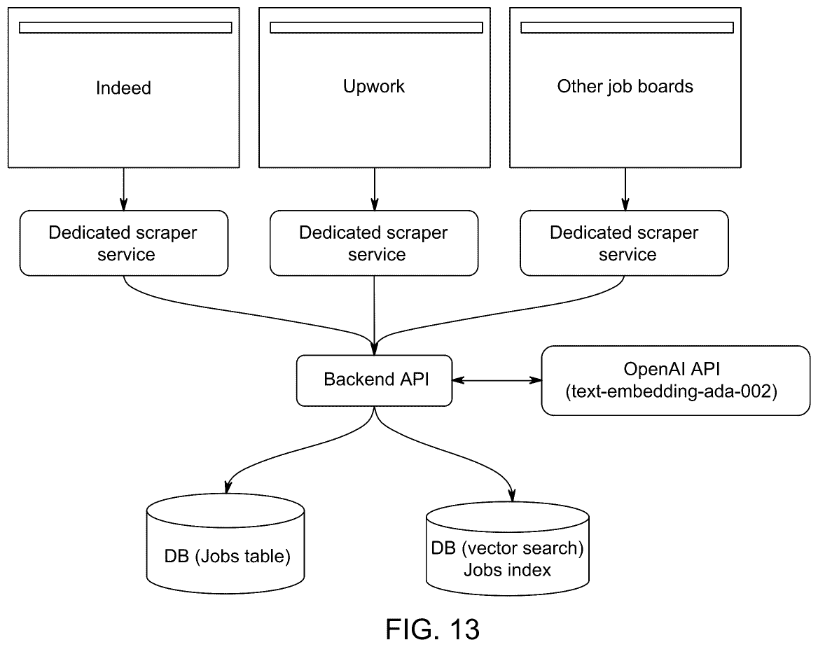

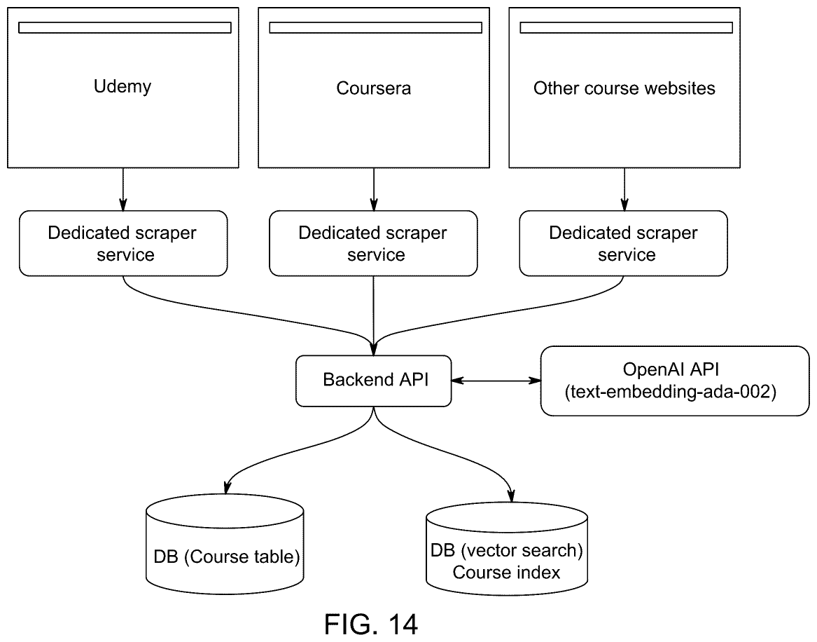

FIG. 13 is a diagram of an embodiment of the building of a jobs database using the services provided by Indeed, Upwork and other job boards. FIG. 14 is a diagram of an embodiment of the building of a course (e.g., courses for improvement recommendations to improve the chances of successfully obtaining the opportunity) database using the services of Udemy, Coursera and other course websites.

This Opportunity Database Creation step can be implemented in one or more “Opportunity Database Creation Modules” (or be combined with one or more other modules).

3. AI Matching: Once the opportunity database has been created, the AI models of embodiments of this invention will use the user's profile information to match them with relevant opportunities and improvement recommendations. The AI models will take into account factors such as the user's location, education, work experience, skills, and preferences, depending on the application, to make the most useful matches.

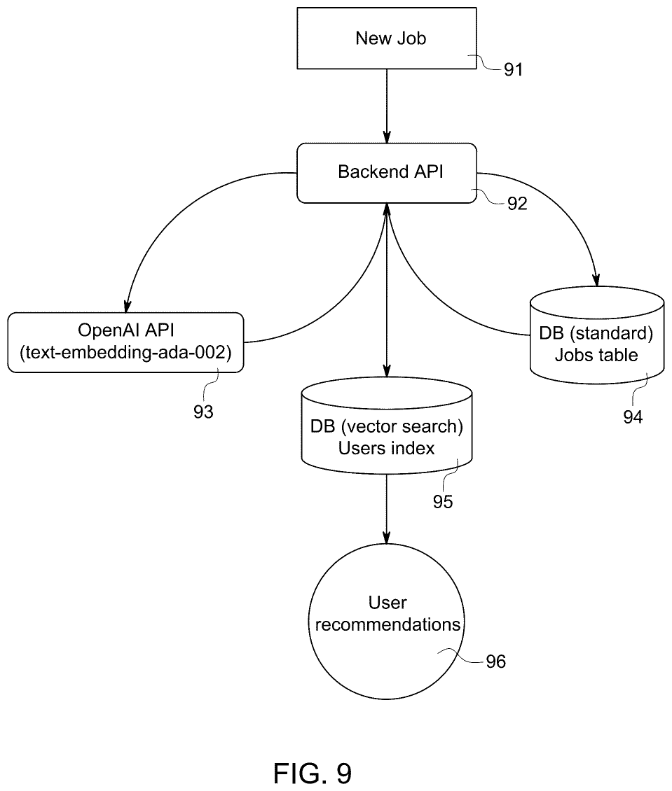

FIG. 9 is a diagram of the matching of a user profile to opportunities from certain embodiments. A New Job 41 is being sought so the Backend API 92 interacts with OpenAI API 93 and a job's table database (“DB”) 94 and a user's index database (“DB”) 95. A user recommendation 96 is also released to the user.

This AI Matching step can be implemented in one or more “AI Matching Modules” (or be combined with one or more other modules).

4. Improvement Recommendations: In addition to matching users with opportunities, the embodiments of this invention will also provide matching recommendations on how to increase the user's chances of landing or succeeding with the opportunity (“improvement recommendations”). For example, if the opportunity is a job, the AI of the embodiments of this invention may recommend online courses or training programs to help the user improve their skills. It may also recommend interviewing strategy. If the opportunity is a date, the AI of the embodiments of this invention may provide talking points or conversation starters based on the matched user profile. For corporate users seeking business (e.g., sales, relationships, partnerships, real estate) the method and apparatus will match them with advertised RFPs and recommend skill gaps to fill if awarded the contract.

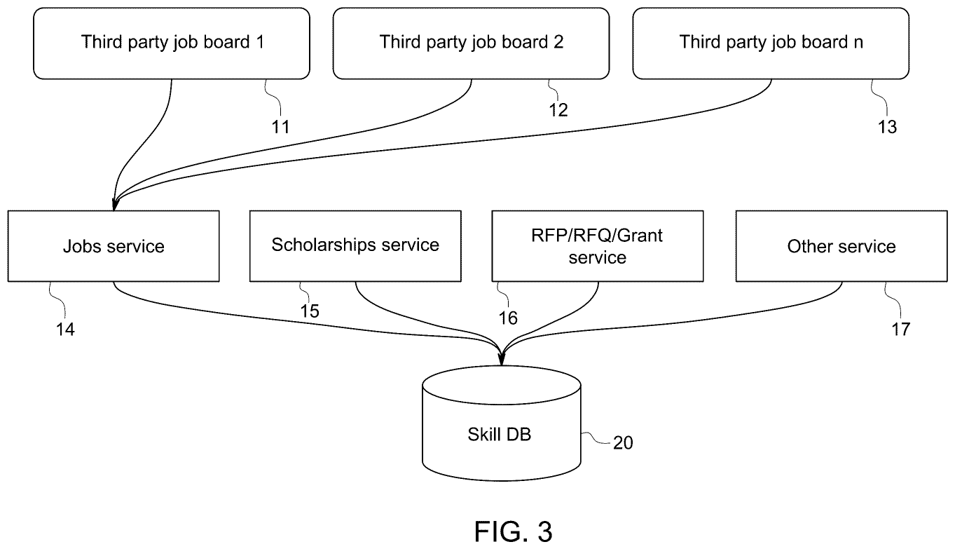

FIG. 3 is a diagram that illustrates several of the specialized services that certain of the embodiments of this invention identify that help users develop their skills to increase their chances of securing opportunities in job search applications (e.g., “Third party job board 1” 11; “Third party job board 2” 12; Third party job board n″ 13; “Jobs service” 14; “Scholarships service” 15; “RFP/RFQ/Grant service” 16; “Other services” 17). In certain job search related embodiments, the embodiments scan (preferably constantly or at regular set intervals) the web for various information concerning skill-building resources, such as courses, tutorials, blog posts, books, and/or specially skilled mentors/employees (in the case of RFP/RFQ response), which is stored in a skill database (“Skill DB” 20), which can be part of or separate from the “Opportunity DB” 10 of FIG. 1 (e.g., a Skill DB can also be referred to as a second opportunity database herein). The backend of each of the embodiments will then use this skill database to provide personalized recommendations to users based on their skills and interests, thereby enabling them to better prepare for securing incoming opportunities.

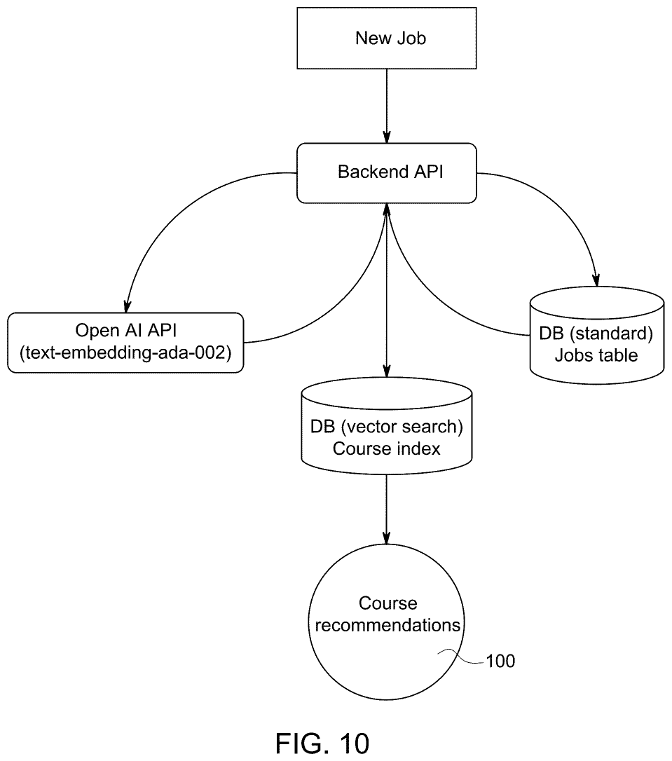

FIG. 10 is a diagram of an improvement recommendation embodiment. Here, a course recommendation 100 is issued from the user from the interactions of the Backend API, OpenAI API, a job table database, and a course index database.

This Improvement Recommendation step can be implemented in one or more “Improvement Recommendation Modules” (or be combined with one or more other modules, such as the Opportunity Database Creation Module).

5. Notification: Once the embodiments of this invention have found relevant opportunities and improvement recommendations, the user will be notified via email or other electronic communication messaging platform. The message/email will contain all the information needed to make a decision on the opportunity, including a brief description, requirements, draft narrative (e.g., including a draft resume in job search applications), and recommendations to improve chances of securing the opportunity. In certain embodiments, this can include creating an artifact that the user leverages to apply for the opportunity (customized resume, customized CV, customized response) (e.g., by generating a resume).

FIG. 9 is a diagram that shows a User or Improvement Recommendation 96. FIG. 10 is a diagram that shows a Course Recommendation 100 for a user.

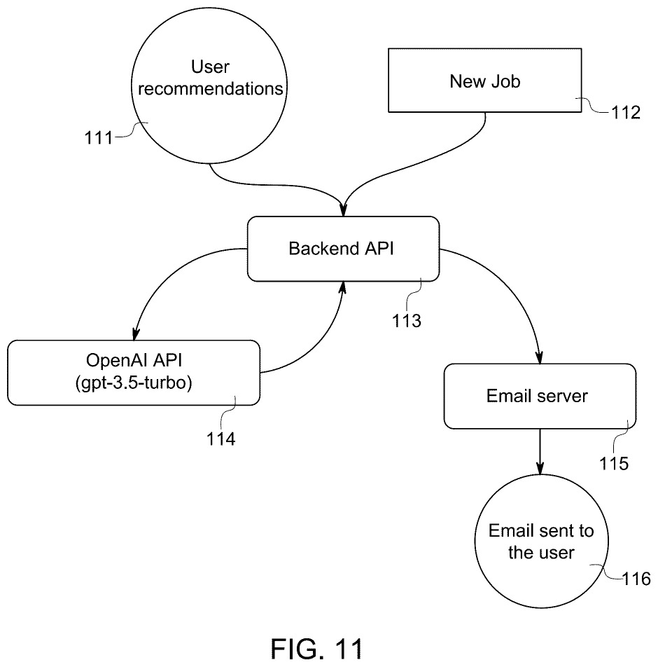

FIG. 11 is a diagram of an embodiment of a dynamic resume generator. User recommendations 111 and new job 112 information are input into the Backend API 112 that interacts with an OpenAI API 114 and then issues via an email server 115 an email to the user with the resume 116. An example of prompts for the AI generation of a resume is described below in Example 2.

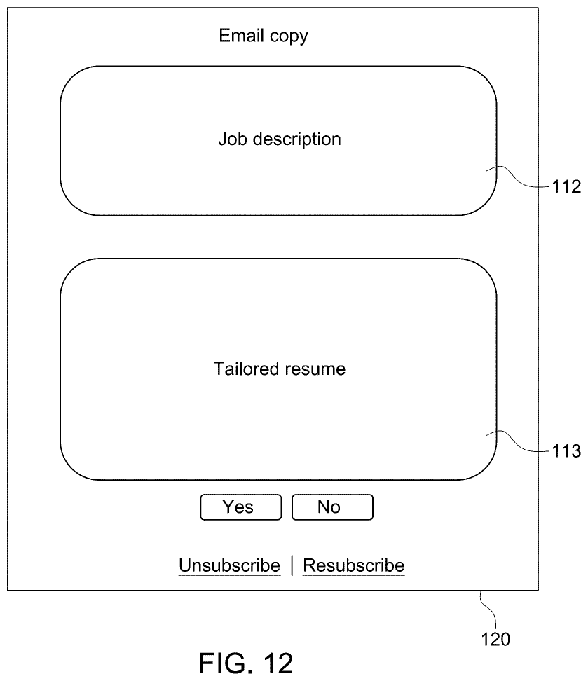

FIG. 12 is a diagram of an embodiment of an email alert set to a user. In this embodiment an email 120 is sent to the user that contains an opportunity description 112 and a tailored application 113.

This Notification step can be implemented in one or more “Notification Modules” (or be combined with one or more other modules). The Notification Module can include a Resume Generator Module in certain embodiments, or the Resume Generator Module can be a separate module.

6. User Feedback: the embodiments of this invention will also collect feedback from users to improve the opportunity matching and improvement recommendation matching results. Users will be able to rate opportunities and provide feedback on the recommendations provided by the embodiments, which will be used to improve future opportunity matches and improvement recommendation matches.

This User Feedback step can be implemented in one or more “User Feedback Modules” (or be combined with one or more other modules).

7. Automation: certain embodiments of this invention will also affect the application for opportunities on behalf of the user based on the system's analysis of the user's profile and the likelihood/probability that the user will win the opportunity. In certain preferred embodiments, this automation submits a created artifact that the user leverages to apply for the opportunity (e.g., customized resume, customized profile, customized CV, customized response), which will facilitate or improve the user's application to the opportunity, and/or otherwise responds to an opportunity on behalf of the user (unattended) by, for example, responding to the opportunity with an application, form, or other type of information, that is filed out by a component (e.g., module) of the invention.

This Automation step can be implemented in one or more “Automation Modules” (or be combined with one or more other modules). In certain of these embodiments, the Automation Module is part of or connected to and in communication with the Notification Module and/or the Resume Generator Module.

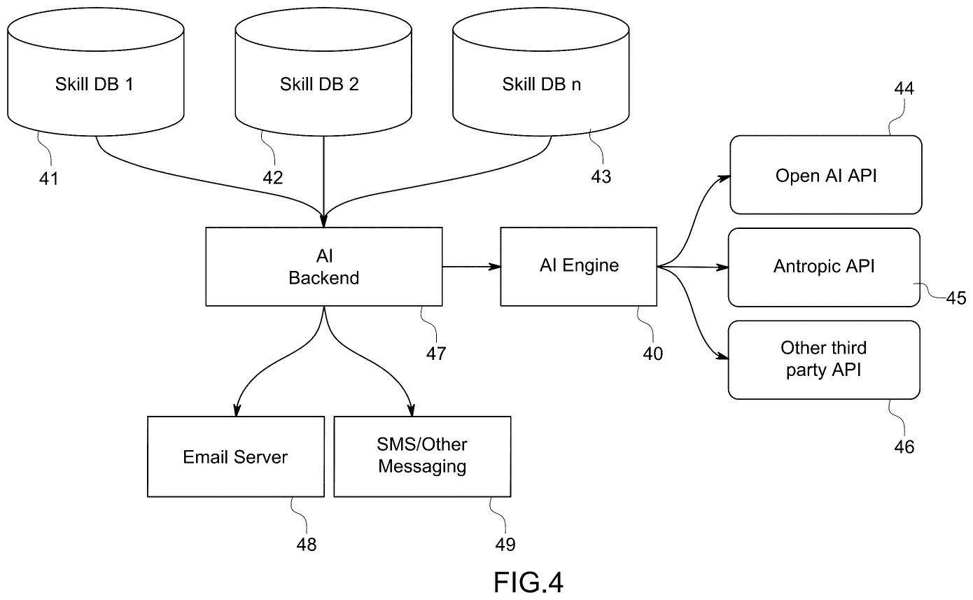

8. Integration of modules. The modules described herein are integrated to provide the described results. FIG. 4 is a diagram that illustrates integration of modules of the embodiments of this invention in job search applications. A person of skill in the art will be aware of other connections and integration, combining of functions and separating out of functions that can be used and still obtain the results described herein. The three skill databases shown as examples (“Skill DB 1” 41; “Skill DB 2” 42; “Skill DB n” 43) will serve as crucial resources for the backend of each of the embodiments to function effectively. Furthermore, each backend (e.g., “AI Backend” 47) via an “AI Engine” 40 will utilize third-party APIs to access advanced AI models (e.g., “OpenAI API” 44; “Antropic API” 45; “Other third party API” 46). Upon successful integration, the backend of each embodiment will notify users of any potential opportunities and provide recommendations for resources that can aid in securing these opportunities (e.g., via “Email Server” 48 and/or SMS/Other Messaging” 49). The end-to-end process is designed to be user-centric and ensure that users are equipped with the necessary tools to make informed decisions about their growth.

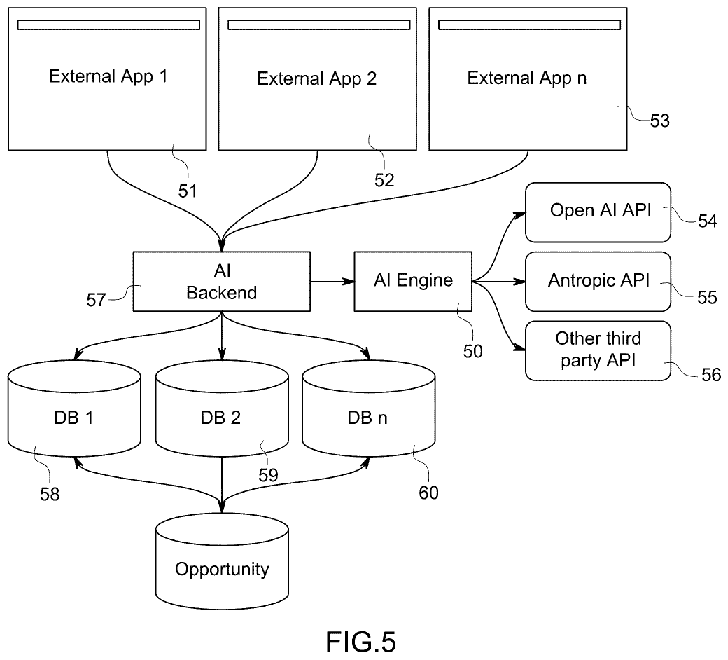

FIG. 5 is a diagram that illustrates the general integration of modules of embodiments of this invention that can be applied to various applications (i.e., not limited to job search applications). Overall, the embodiments of this invention use a combination of AI-driven matching and web crawling to provide users with personalized and relevant opportunities. By providing recommendations and feedback, the methods and apparatus can continuously improve and provide better matches and recommendations over time.

In FIG. 5, external applications are shown (i.e., “External App 1” 51; “External App 2” 52; “External App n” 53) that can be third party job boards in job search applications. These applications witll scan the web for opportunities and store them in opportunity (e.g., “Skill” in some embodiments) databases (e.g., “Opportunity DB 1” 58; “Opportunity DB 2” 59; “Opportunity DB n” 60) through the AI Backend 57. The AI Backend 57 using an AI Engine 50 will utilize third party APIs to access advanced AI models (e.g., “Open AI API” 54; “Antropic API” 55; “Other third party API” 56). Upon successful integration, the backend will notify users of any potential opportunities and provide recommendations for resources that can aid in securing those opportunities.

9. Types of opportunities. Applications for job searches and several other applications are exemplified herein. Additional applications also are possible, some of which are listed below, although a person of skill in the art will be able to apply the teaching set forth herein to apply this invention to additional applications not listed.

Job search: Certain embodiments of this invention can search for job opportunities that match a users work history and ideal job description. These embodiments can then prepare a resume specific to that job based on the user's background, recommend training to help the user align to the job and apply on behalf of the user.

Scholarship search: Certain embodiments of this invention can search for job opportunities that match a user's work history and ideal job description. These embodiments can then prepare a resume specific to that job based on the user's background, recommend training to help the user align to the job and apply on behalf of the user. search for scholarship opportunities that match a user's academic profile, such as their GPA, extracurricular activities, and field of study. These embodiments can then create the user's application letter and other submissions and give the user information, training, or tasks (i.e., volunteer opportunities) that can improve their chances of winning the scholarship.

Volunteer opportunities: Certain embodiments of this invention can search for job opportunities that match a users work history and ideal job description. These embodiments can then prepare a resume specific to that job based on the user's background, recommend training to help the user align to the job and apply on behalf of the user. could search for volunteer opportunities that match a user's interests, such as environmental conservation or animal welfare. These embodiments can create a narrative for the user that can be submitted to the volunteer organization to initiate correspondence.

Event planning: Certain embodiments of this invention can search for job opportunities that match a users work history and ideal job description. These embodiemts can then prepare a resume specific to that job based on the user's background, recommend training to help the user align to the job and apply on behalf of the user and can search for events that match a user's preferences, such as music festivals, conferences, or networking events. These embodiments can provide links to purchase tickets, arrange travel or suggest the best seats at the event.

Travel planning: Certain embodiments of this invention can search for job opportunities that match a users work history and ideal job description. These embodiments can then prepare a resume specific to that job based on the users background, recommend training to help the user align to the job and apply on behalf of the user, search for travel deals and opportunities that match a users budget, travel preferences, and destination interests. These embodiments can pass information to the user for final purchase and suggest events or activities during travel.

Mentorship matching: Certain embodiments of this invention can search for job opportunities that match a user's work history and ideal job description. These embodiments can then prepare a resume specific to that job based on the user's background, recommend training to help the user align to the job and apply on behalf of the user, match users with mentors in their field of interest based on their experience, skills, and career goals. The methods and apparatus can then create a narrative that can initiate correspondence with the potential mentor.

Real estate search: Certain embodiments of this invention can search for job opportunities that match a users work history and ideal job description. These embodiments can then prepare a resume specific to that job based on the user's background, recommend training to help the user align to the job and apply on behalf of the user, search for real estate properties that match a user's preferences, such as location, price range, and property type. These embodiment can then provide the user with information on the value and potential post-renovation value of the property or the future value. These embodiment can also provide the user with an offer strategy to ensure that the user saves money and does well in the bidding process.

Personal finance: Certain embodiments of this invention can search for job opportunities that match a users work history and ideal job description. These embodiments can then prepare a resume specific to that job based on the user's background, recommend training to help the user align to the job and apply on behalf of the user, search for investment opportunities that match a user's financial goals, risk tolerance, and investment preferences. These embodiments can create research documentation and provide contact information to professionals who can help the user move forward or learn more about the investment opportunity.

Creative pursuits: Certain embodiments of this invention can search for job opportunities that match a user's work history and ideal job description. These embodiments can then prepare a resume specific to that job based on the user's background, recommend training to help the user align to the job and apply on behalf of the user, search for opportunities that match a user's creative pursuits, such as art competitions, writing contests, or photography workshops. These embodiments can create a narrative and message to the group hosting the competition.

Health and wellness: Certain embodiments of this invention can search for job opportunities that match a user's work history and ideal job description. These embodiments can then prepare a resume specific to that job based on the user's background, recommend training to help the user align to the job and apply on behalf of the user, could search for opportunities that match a user's health and wellness goals, such as fitness classes, meditation retreats, or healthy meal delivery services. These embodiments can provide links to books or other fitness training material. These embodiments can provide a list of fitness groups or trainers. These embodiments can also track ther user's progress and prepare a report that can go to a trainer or healthcare professional with a log of the wellness activities completed by the user.

Language learning: Certain embodiments of this invention can search for job opportunities that match a user's work history and ideal job description. These embodiments can then prepare a resume specific to that job based on the user's background, recommend training to help the user align to the job and apply on behalf of the user, search for language learning opportunities that match a user's language proficiency, learning style, and interests. These embodiments can can provide training material and quiz the user to determine the user's level of proficiency or improvement in mastering the language. Based on proficiency These embodiments can can suggest travel or local opportunities to become immersed in the new language.

Entrepreneurship: Certain embodiments of this invention can search for job opportunities that match a user's work history and ideal job description. These embodiments can then prepare a resume specific to that job based on the user's background, recommend training to help the user align to the job and apply on behalf of the user, could search for entrepreneurship opportunities that match a user's business goals, industry preferences, and skill set. These embodiments can prepare RFP/RFQ responses. These embodiments can can help the company identify talent gaps and suggest ways to fill talent gaps that are critical for winning the opportunity.

Overall, the embodiments of this invention have the potential to be used for any type of opportunity search that can benefit from the use of AI-based matching and recommendations.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

An implementation of embodiments of this invention are AI powered job search embodiments. These embodiments find jobs that match a user's (e.g., job seeker's) skills/interests to job opportunities (e.g., job descriptions or listings on websites such as (www.monster.com). These embodiments also provide dynamic resume creation that aligns a user's skills and interests to a job description or listing. In certain of these embodiments, the job descriptions or listings that are identified and resumes that are generated are emailed to the user. In other embodiments, the job is applied for on the user's behalf in an automated manner by the embodiment by sending the resume and any other necessary information automatically to the source of the job description or listing to apply to the job.

### Example 2

A preferred embodiment of a matching and resume generation embodiment of this invention is described in this example. This embodiment uses three stages.

### Stage I (User profile)

1. User creates a profile.
   Users provide their personal information and details relevant to their job search, such as their name, contact information, education, work experience, skills, and preferences.
   This information is collected through a web form on the profile section of the website.
2. User profile gets saved to MongoDB database.
   The user profile data is stored in a MongoDB database, which is a NoSQL database known for its flexibility and scalability.
3. User record is sent to OpenAI's embedding model for vectorization, where the user record is changed into a vector (embedding).
   The user profile data is passed to OpenAI's embedding model, which is designed to convert text-based information into dense vector representations (embeddings).
   The embedding model processes the user's profile text, capturing semantic and contextual information, and generates a vector representation that encodes the profile's characteristics.
4. The user profile embedding alongside with the record Id is sent to a vector index database (Pinecone).
   The user profile embedding, which represents the user's profile as a numerical vector, is sent to a vector index database called Pinecone.
   Pinecone is a vector search database that specializes in efficient similarity search and retrieval of high-dimensional vectors.
   The user profile embedding, along with a unique identifier (record ID), is stored in Pinecone's index, allowing for fast and accurate matching with job profiles in later stages.

In summary, Stage I involves users creating their profiles, which are then saved in a MongoDB database. The user profiles are vectorized using OpenAI's embedding model, and the resulting embeddings, along with record IDs, are stored in the vector index database (Pinecone). This sets the foundation for the subsequent stages, where the user profiles will be matched with job profiles based on their vector representations.

### Stage II (Matching)

1. Job scraper adds jobs to mongodb database.
   A job scraper collects job postings from Indeed (job board)
   The scraped job information, including job titles and descriptions is stored in a MongoDB database.
2. Job record is sent to OpenAI's embedding model for vectorization. Where the job record is changed to a vector (embedding).
   Each job record from the MongoDB database is sent to OpenAI's embedding model to generate a vector representation (embedding) of the job.
   The embedding model processes the job description text, capturing important semantic and contextual information, and produces a numerical vector that represents the job's characteristics.
3. Job record embedding is used to find matching user profiles to the jobs using a vector search database (Pinecone).
   The job record embedding is utilized to search for similar user profiles in the vector search database (Pinecone).
   By querying Pinecone with the job record embedding, the methods and apparatus retrieve the most relevant user profile embeddings that match the characteristics of the job.
   Pinecone's vector search capabilities enable efficient and accurate retrieval of user profiles that are likely to be a good fit for the job.
4. Select user profiles that score more than 0.9 match in the vector search.
   Based on the similarity scores obtained from the vector search, a threshold of 0.9 is set to determine the level of matching required.
   User profiles that score above this threshold, indicating a high degree of similarity with the job profile, are selected as potential matches.
   These selected user profiles are considered to have a strong alignment with the requirements and preferences outlined in the job description.

In summary, Stage II involves adding job profiles to the MongoDB database scraped by the job scraper. Each job profile is then vectorized using OpenAI's embedding model, generating a numerical representation of the job. The job record embeddings are used to search for matching user profiles in the vector search database (Pinecone), based on their similarity scores. User profiles that exceed the 0.9 threshold are selected as potential matches for the job. This matching process sets the stage for the subsequent stage, where resumes will be generated for the selected user profiles.

### Stage III (Resume Generation)

1. Selected user profiles matching a job are used to generate resumes using OpenAI's ‘gpt-3.5-turbo’ model. (The exact prompt used is presented below)
   The user profiles that were identified as potential matches in Stage II are utilized for resume generation.
   OpenAI's ‘gpt-3.5-turbo’ model, known for its language generation capabilities, is employed to generate resumes based on the selected user profiles.
   The specific prompt provided to the model might include relevant details from the job description and user's profile, requesting it to generate a tailored resume.
2. A PDF is created from ‘gpt-3.5-turbo’ response using the ‘puppeteer’ library.
   Once the ‘gpt-3.5-turbo’ model generates the resume text, it is converted into a PDF format for easy sharing and viewing.
   The ‘puppeteer’ library, which provides a high-level API for controlling headless Chrome or Chromium, is used to generate the PDF document from the resume text.
3. An email is sent to the user with the job description and PDF as an attachment.
   The methods and apparatus composes an email containing the job details about the job for which the resume was generated.
   The email is sent to the user's provided email address, ensuring that the user receives both the job details and the tailored resume.
4. User record is updated with the recommended job.
   The recommended job, for which the resume was generated, is associated with the user's profile record.
   This update allows for tracking and reference purposes, providing a clear indication of the recommended job for the user.

In summary, Stage III involves utilizing the selected user profiles from Stage II to generate tailored resumes using OpenAI's ‘gpt-3.5-turbo’ model. The generated resume text is converted into a PDF document using the ‘puppeteer’ library. An email is composed, including the job description and the PDF resume as an attachment, and sent to the user. Finally, the user's profile record in the MongoDB database is updated to reflect the recommended job associated with the generated resume.

In a preferred embodiment of this invention, an example of a prompt for generating resumes for users can be as follows:

You are an advanced AI that generates resume for a candidate profile that is tailored for a specific job description. The candidate profile is going to be given directly from the database record and going to be in an object format.
You only return the resume and don't include any more details.
The resume will contain an objective.
The resume does not include the Ideal Job description.
The resume generated is of a very high quality and will help the candidate land the job.
The response will be html formatted and the resume will have a maximum width of 800 pixels with a gray border and curved edges.
The header container text are centered to be in the middle.
The resume is in first person as if the candidate wrote it himself.
The other sections will have the title (section name) on the top and the description below.
You don't use any horizontal dividers.
The resume will include a header with the name and contact information of the candidate, a professional summary that briefly highlights the skills, experiences and accomplishments of the candidate, an objective to explain the type of job the candidate is seeking and hope to accomplish in that position.
The resume will include the work experience to give a brief description of the responsibilities and achievements in each role and dates of employment, an education section should include the highest level of education, the degree obtained and date of attendance, section to show case skills of the candidate.
The resume will not be reviewed so should not have any place holders to be filled by the candidate.

### Example 3

This example sets forth a preferred embodiment for a method for identifying for a user, from the internet, (i) multiple job opportunities specific for the user, and (ii) multiple improvement recommendations specific for the user. The method comprises a number of steps, certain of which can be combined together or done in pieces, as will be apparent to a person of skill in the art.

One step is the creating of a user profile of at least three different personal information categories concerning the user from information input by the user and/or collected from social media concerning the user. Generally, more categories of information that are collected are better than less, because more specific and better quality matches may be the result.

Another step is creating a first opportunity database using multiple webcrawlers and/or multiple application program interfaces to collect from the internet and store in the first opportunity database multiple job opportunities. In addition, a second opportunity database using multiple webcrawlers and/or multiple application program interfaces to collect from the internet and store in the second opportunity database multiple improvement recommendations. The first opportunity database and the second opportunity database can be combined into one database, or be different portions of the same database.

Another step is the matching of the contents of the first opportunity database with the user profile using artificial intelligence to identify multiple job opportunities specific for the user. In addition, the matching the contents of the second opportunity database with the user profile using artificial intelligence is accomplished to identify multiple improvement recommendations specific for the user.

Another step is notifying the user of the multiple job opportunities specific for the user. In addition, notifying the user of the multiple improvement recommendations specific for the user is done. This notification can be done in the same email or message to the user, so that one such communication contains both the multiple job opportunities specific for the user and the multiple improvement recommendations specific for the user. The notification in some embodiments can include a resume that was generated with respect to one or more of the job opportunities. The resume can be generated by AI.

Another step is providing feedback from the user on the usefulness of the method. The feedback is provided to the matching steps on the usefulness of the multiple job opportunities specific for the user and the multiple improvement recommendations specific for the user to enhance the usefulness of the matches provided to the user.

### Example 4

Example 3 above was directed to job opportunities and related improvement recommendations. This example can be directed to different opportunities and related improvement recommendations, such as dating opportunities and/or business (e.g., sales, relationships, partnerships, real estate) opportunities. A longer list of potential yet non-limiting opportunity applications would include job opportunities, dating opportunities, business opportunities, scholarship opportunities, volunteer opportunities, event planning opportunities, travel opportunities, mentorship opportunities, real estate opportunities, personal finance opportunities, creative pursuit opportunities, health and wellness opportunities, language learning opportunities, and/or entrepreneurship opportunities.

### Example 5

This example sets forth a preferred embodiment for an apparatus comprised on multiple components for identifying for a user, from the internet, (i) multiple job opportunities specific for the user, and (ii) multiple improvement recommendations specific for the user. The apparatus comprises a number of modules, certain of which can be combined together or done in pieces, in one or more components, as will be apparent to a person of skill in the art.

The apparatus of this example is used for identifying from the internet, and notifying a user of, (i) multiple job opportunities specific for the user, and (ii) multiple improvement recommendations specific for the user.

The apparatus comprises several modules, including (a) a User Profile Creation Module that is used to create a user profile of at least three different personal information categories concerning the user from information input by the user and/or collected from social media concerning the user. Generally, more categories of information collected will improve the results as compared to less categories.

The apparatus also includes (b) an Opportunity Database Creation Module that creates (i) a first opportunity database from multiple webcrawlers and/or multiple application program interfaces that collect from the internet and store in the first opportunity database multiple job opportunities, and (ii) a second opportunity database using multiple webcrawlers and/or multiple application program interfaces to collect from the internet and store in the second opportunity database multiple improvement recommendations. The first opportunity database and the second opportunity database can be comprised of two or more separate physical databases or they can be combined in one physical database.

The apparatus also includes (c) an AI Matching Module that matches (i) the contents of the first opportunity database with the user profile using artificial intelligence to identify multiple job opportunities specific for the user, and (ii) the contents of the second opportunity database with the user profile using artificial intelligence to identify multiple improvement recommendations specific for the user.

The apparatus also includes (d) a Notification Module that informs the user of (i) the multiple job opportunities specific for the user, and (ii) the multiple improvement recommendations specific for the user.

The apparatus also includes (e) a User Feedback Module that provides feedback from the user on the multiple job opportunities specific for the user, and the multiple improvement recommendations specific for the user, to the AI Matching Module to improve the matching results of the AI Matching Module.

In certain embodiments, the Notification Module includes a Resume Generator Module that prepares and provides a resume to the user for one or more of the multiple job opportunities specific for the user.

In certain embodiments, an Automation Module can affect an employment application or other similar response by providing the information requested (e.g., name, address, experience), using AI or otherwise (e.g., extract information from the user profile), and submit the application or other similar response on behalf of the user.

### Example 6

Example 5 above was directed to job opportunities and related improvement recommendations. This example can be directed to different opportunities and related improvement recommendations, such as dating opportunities and/or business (e.g., sales, relationships, partnerships, real estate) opportunities. A longer list of potential yet non-limiting opportunity applications that could be used with this invention would include job opportunities, dating opportunities, business opportunities, scholarship opportunities, volunteer opportunities, event planning opportunities, travel opportunities, mentorship opportunities, real estate opportunities, personal finance opportunities, creative pursuit opportunities, health and wellness opportunities, language learning opportunities, and/or entrepreneurship opportunities.

### Particular Applications To Computer Devices

The methods and apparatus applied to embodiments of this invention to perform the method steps and/or comprise the apparatus may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions and that in certain embodiments these can be provided in the form of one or more modules. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A method for identifying from the internet, and notifying a user of, (i) multiple job opportunities specific for the user, and (ii) multiple improvement recommendations specific for the user and each opportunity, the method comprising:
(a) creating a user profile of at least three different personal information categories concerning the user from information input by the user and/or collected from social media concerning the user;
(b) creating a first opportunity database using multiple webcrawlers and/or multiple application program interfaces to collect from the internet and store in the first opportunity database multiple job opportunities;
(c) creating a second opportunity database using multiple webcrawlers and/or multiple application program interfaces to collect from the internet and store in the second opportunity database multiple improvement recommendations;
(d) matching the contents of the first opportunity database with the user profile using artificial intelligence to identify multiple job opportunities specific for the user;
(e) matching the contents of the second opportunity database with the user profile using artificial intelligence to identify multiple improvement recommendations specific for the user and each opportunity;
(f) notifying the user of the multiple job opportunities specific for the user;
(g) notifying the user of the multiple improvement recommendations specific for the user and each opportunity;
(h) providing feedback to the step (d) matching and the step (e) matching on the usefulness of the multiple job opportunities specific for the user and the multiple improvement recommendations specific for the user;
(i) providing an artifact concerning at least one job opportunity that the user can use to improve the user's application to that job opportunity; and
(i) applying for at least one job opportunity by providing information requested by that job opportunity to affect the application.

2. The method of claim 1 wherein step (i) includes the preparation and providing of a resume to the user for one job opportunity that is specific to the user and the opportunity.

3. Apparatus for identifying from the internet, and notifying a user of, (i) multiple job opportunities specific for the user, and (ii) multiple improvement recommendations specific for the user and each opportunity, the apparatus comprising:
(a) a User Profile Creation Module that is used to create a user profile of at least three different personal information categories concerning the user from information input by the user and/or collected from social media concerning the user;
(b) an Opportunity Database Creation Module that creates (i) a first opportunity database from multiple webcrawlers and/or multiple application program interfaces that collect from the internet and store in the first opportunity database multiple job opportunities, and (ii) a second opportunity database using multiple webcrawlers and/or multiple application program interfaces to collect from the internet and store in the second opportunity database multiple improvement recommendations;
(c) an AI Matching Module that matches (i) the contents of the first opportunity database with the user profile using artificial intelligence to identify multiple job opportunities specific for the user, and (ii) the contents of the second opportunity database with the user profile using artificial intelligence to identify multiple improvement recommendations specific for the user and each opportunity;
(d) a Notification Module that informs the user of (i) the multiple job opportunities specific for the user, and (ii) the multiple improvement recommendations specific for the user, and provides an artifact to the user requested by at least one of the job opportunities that the user can use to improve the user's application to that job opportunity;
(e) a User Feedback Module that provides feedback from the user on the multiple job opportunities specific for the user, and the multiple improvement recommendations specific for the user, to the AI Matching Module to improve the matching results of the AI Matching Module; and
(f) an Automation Module that applies for at least one job opportunity by providing information requested by that job opportunity to affect the application.

4. The apparatus of claim 3 wherein the Notification Module includes a Resume Generator Module that prepares and provides the artifact that is a resume to the user for one job opportunity that is specific to the user and the opportunity.

5. A method for identifying from the internet, and notifying a user of, (i) multiple opportunities specific for the user, and (ii) multiple improvement recommendations specific for the user, the method comprising:
(a) creating a user profile of at least three different personal information categories concerning the user from information input by the user and/or collected from social media concerning the user;
(b) creating a first opportunity database using multiple webcrawlers and/or multiple application program interfaces to collect from the internet and store in the first opportunity database multiple opportunities;
(c) creating a second opportunity database using multiple webcrawlers and/or multiple application program interfaces to collect from the internet and store in the second opportunity database multiple improvement recommendations for each opportunity;
(d) matching the contents of the first opportunity database with the user profile using artificial intelligence to identify multiple opportunities specific for the user;
(e) matching the contents of the second opportunity database with the user profile using artificial intelligence to identify multiple improvement recommendations specific for the user and each opportunity;
(f) notifying the user of the multiple opportunities specific for the user;
(g) notifying the user of the multiple improvement recommendations specific for the user and each opportunity;
(h) providing feedback to the step (d) matching and the step (e) matching on the usefulness of the multiple opportunities specific for the user and the multiple improvement recommendations specific for the user and each opportunity;
(i) providing an artifact to the user concerning at least one opportunity that the user can use to improve the user's application to that opportunity; and
(i) applying for at least one opportunity by providing information requested by that opportunity to affect the application.

6. The method of claim 5 wherein the opportunities are job opportunities and dating opportunities.

7. The method of claim 5 wherein the opportunities are job opportunities, dating opportunities, and/or business opportunities.

8. The method of claim 5 wherein the opportunities are job opportunities, dating opportunities, business opportunities, scholarship opportunities, volunteer opportunities, event planning opportunities, travel opportunities, mentorship opportunities, real estate opportunities, personal finance opportunities, creative pursuit opportunities, health and wellness opportunities, language learning opportunities, and/or entrepreneurship opportunities.

9. An apparatus for identifying from the internet, and notifying a user of, (i) multiple opportunities specific for the user, and (ii) multiple improvement recommendations specific for the user for each opportunity, the apparatus comprising:
(a) User Profile Creation Module that is used to create a user profile of at least three different personal information categories concerning the user from information input by the user and/or collected from social media concerning the user;
(b) an Opportunity Database Creation Module that creates (i) a first opportunity database from multiple webcrawlers and/or multiple application program interfaces that collect from the internet and store in the first opportunity database multiple opportunities, and (ii) a second opportunity database using multiple webcrawlers and/or multiple application program interfaces to collect from the internet and store in the second opportunity database multiple improvement recommendations for each opportunity;
(c) an AI Matching Module that matches (i) the contents of the first opportunity database with the user profile using artificial intelligence to identify multiple opportunities specific for the user, and (ii) the contents of the second opportunity database with the user profile using artificial intelligence to identify multiple improvement recommendations specific for the user and each opportunity;
(d) a Notification Module that informs the user of (i) the multiple opportunities specific for the user, and (ii) the multiple improvement recommendations specific for the user, and provides an artifact to the user requested by at least one of the opportunities that the user can use to improve the user's application to that opportunity;
(e) a User Feedback Module that provides feedback from the user on the multiple opportunities specific for the user, and the multiple improvement recommendations specific for the user and each opportunity, to the AI Matching Module to improve the matching results of the AI Matching Module; and
(f) an Automation Module that applies for at least one opportunity by providing information requested by that opportunity to affect the application.

10. The apparatus of claim 9 wherein the opportunities are job opportunities and dating opportunities.

11. The apparatus of claim 9 wherein the opportunities are job opportunities, dating opportunities, and/or business opportunities.

12. The apparatus of claim 9 wherein the opportunities are job opportunities, dating opportunities, business opportunities, scholarship opportunities, volunteer opportunities, event planning opportunities, travel opportunities, mentorship opportunities, real estate opportunities, personal finance opportunities, creative pursuit opportunities, health and wellness opportunities, language learning opportunities, and/or entrepreneurship opportunities.
